(19) United States
(12) Patent Application Publication
(10) Pub. No.: US 2015/0143293 A1
(43) Pub. Date: May 21, 2015

(54) COMPONENT DETERMINATION AND GAZE PROVOKED INTERACTION

(71) Applicant: Tobii Technology AB, Danderyd (SE)

(72) Inventors: Erland George-Svahn, Solna (SE); Rebecka Lannsjö, Solna (SE); Aron Yu, Stockholm (SE)

(21) Appl. No.: 14/547,089

(22) Filed: Nov. 18, 2014

Related U.S. Application Data
(60) Provisional application No. 61/905,536, filed on Nov. 18, 2013.

(51) Int. Cl. G06F 3/01; G06F 3/0484; G06F 3/0488; G06F 3/0482

(52) U.S. Cl. CPC G06F 3/013; G06F 3/0482; G06F 3/04842; G06F 3/04883
USPC 715/815; 715/835; 715/822

(57) ABSTRACT

According to the invention, a method for selecting a program from a list of programs is disclosed. The method may include receiving an indication that a first non-gaze input has been received. The method may also include causing a list of programs to be shown on a display. The method may further include receiving information identifying a location of the gaze point of the user on the display. The method may additionally include receiving an indication that a second non-gaze input has been received. The method may moreover include, based at least in part on the location of the gaze point, causing a program from the list to be shown on the display upon receipt of the second non-gaze input.

### CROSS-REFERENCE TO RELATED APPLICATIONS

This application claims priority to Provisional U.S. Patent Application No. 61/905,536 filed Nov. 18, 2013, entitled “COMPONENT DETERMINATION AND GAZE PROVOKED INTERACTION,” the entire disclosure of which is hereby incorporated by reference, for all purposes, as if fully set forth herein.

This application is also related to U.S. patent application Ser. No. 14/547,087 filed Nov. 18, 2014, entitled “COMPONENT DETERMINATION AND GAZE PROVOKED INTERACTION,” the entire disclosure of which is hereby incorporated by reference, for all purposes, as if fully set forth herein.

### BACKGROUND OF THE INVENTION

The present invention generally relates to systems and methods for determining components for gaze provoked interactions and in particular, to systems and methods for performing gaze provoked interactions.

Detection of a user's gaze direction by an eye tracking device has enabled a new generation of computer input. As accuracy of eye tracking devices has improved, it is now possible to determine with good accuracy a point on a computer display at which a user is looking. This information can be used to drive a computer in whole, or at least in part.

There are specific advantages in combining gaze input with a physical or more traditional input such as a mouse, keyboard, touchpad, touchscreen, voice, or the like. This allows for a faster and more natural feeling interaction with a computer, as a user's gaze is usually a precursor to an action being performed on the computer. For example, a user will look at an icon before clicking it with a computer mouse. Knowing in advance the possibility of an action being performed advantageous for programs running on a computer.

However, there exist problems for implementing user-input schemes which take advantage of this additional gaze information. For example, different computer programs and on-screen components behave differently. It may therefore be beneficial to tailor gaze interaction as dependent upon the context within which a user is interacting with a computer program.

Further, the type of interaction with the computer program or on-screen component potentially caused by a gaze interaction must be described or otherwise made known to the user. It provides a great advantage to a user if a gaze based interaction is enhanced or otherwise improved over a traditional interaction. In other words, to merely mimic a known and/or previously existing interaction by starting an interaction with a gaze of a user's eyes might may not be as advantageous as a faster, more intuitive, and/or enhanced interaction.

Embodiments of the present invention provides solutions to these and other problems.

### BRIEF DESCRIPTION OF THE INVENTION

In one embodiment, a method for selecting a program from a list of programs is provided. The method may include receiving an indication that a first non-gaze input has been received. The method may also include causing a list of programs to be shown on a display. The method may further include receiving information identifying a location of the gaze point of the user on the display. The method may additionally include receiving an indication that a second non-gaze input has been received. The method may moreover include, based at least in part on the location of the gaze point, causing a program from the list to be shown on the display upon receipt of the second non-gaze input.

In another embodiment, a non-transitory machine readable medium is provided. The medium may have instructions stored thereon for selecting a program from a list of programs. The instructions may be executable by at least one processor for at least receiving an indication that a first non-gaze input has been received. The instructions may also be executable for causing a list of programs to be shown on a display. The instructions may further be executable for receiving information identifying a location of the gaze point of the user on the display. The instructions may additionally be executable for receiving an indication that a second non-gaze input has been received. The instructions may moreover be executable for, based at least in part on the location of the gaze point, causing a program from the list to be shown on the display upon receipt of the second non-gaze input.

### BRIEF DESCRIPTION OF THE DRAWINGS

The present invention is described in conjunction with the appended figures:

FIG. 1 is a block diagram of one method of an embodiment of the invention for causing a zoom on a display based on a gaze input;

FIG. 2 is a block diagram of another method of an embodiment of the invention for causing a zoom on a display based on a gaze input;

FIG. 3 is a block diagram of a method of an embodiment of the invention for causing a scroll on a display based on a gaze input;

FIG. 4 is a block diagram of another method of an embodiment of the invention for causing a scroll on a display based on a gaze input;

FIG. 5 is a block diagram of a method of an embodiment of the invention for selecting a program from a list of programs based on a gaze input; and

FIG. 6 is a block diagram of an exemplary system capable of being used in at least some portion of the apparatuses or systems of the present invention, or implementing at least some portion of the methods or procedures of the present invention.

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION OF THE INVENTION

The ensuing description provides exemplary embodiments only, and is not intended to limit the scope, applicability or configuration of the disclosure. Rather, the ensuing description of the exemplary embodiments will provide those skilled in the art with an enabling description for implementing one or more exemplary embodiments. One of skill in the art will understand that various changes may be made in the function and arrangement of elements without departing from the spirit and scope of the invention as set forth in the appended claims. For example, not every detail of each embodiment discussed herein may be present in all versions of that embodiment, or details of one embodiment discussed herein may be present in any other embodiment discussed herein, or any possible version of those other embodiments.

Specific details are given in the following description to provide a thorough understanding of the embodiments. However, it will be understood by one of ordinary skill in the art that the embodiments may be practiced without these specific details. For example, circuits, systems, networks, processes, and other elements in the invention may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but could have additional steps not discussed or included in a figure. Furthermore, not all operations in any particularly described process may occur in all embodiments, or there may be additional operations not discussed with specific regard to the particular process. A process may correspond to a method, a function, a procedure, a subroutine, a subprogram, etc. When a process corresponds to a function, its termination corresponds to a return of the function to the calling function or the main function.

Furthermore, embodiments of the invention may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. One or more processors may perform the necessary tasks.

In some embodiments of the invention, systems and methods are provided for effectively performing gaze provoked interactions and for defining gaze provoked interactions themselves. In one embodiment, there may be provided systems and methods for determining suitable gaze provoked interactions during a given point in time. Merely by example, the method may include determining the types of computer programs and on-screen components available on a computing system. The method may also include determining possible gaze provoked interactions for each computer program and on-screen component. The method may further include, upon activation of a computer program or on-screen component, determining the most relevant gaze provoked interaction, and then performing the gaze provoked interaction.

In some embodiments, a computer program may typically show various on-screen components via a display. These components may include, but are not limited to, buttons, text, menus, scrollable windows, images, windows capable of zoom, and the like.

Typically a computer system executes software that describes typical interactions with the on-screen components, for example a button may be activated by a left mouse click; or a scrollable window may scroll up or down using a scroll wheel on a mouse, or arrow keys on a keyboard.

Computer software may be executed by the computer system which determines the components displayable on-screen and determines which gaze provoked interactions may be utilized to interact with those components. A gaze provoked interaction is an interaction whereby a user's gaze is a key part of the interaction, examples of gaze provoked interactions will be described below.

Once the computer software has determined possible gaze provoked interactions for the displayed components, it may quickly and efficiently perform that gaze provoked interaction once it has been activated by a user. Activation may often be initiated by a non-gaze input such as pressing of a button, key, and/or at least some portion of a touchpad. Additionally, voice or other auditory commands may be used whenever non-gaze inputs are discussed herein. Specific methods for activating gaze provoked interactions will also be described below.

In some embodiments, the computer software may inject or otherwise take control of the on-screen components or actions performed by the on-screen components to provide enhanced functionality. For example, a scrollable window may typically be scrolled a predetermined amount when a down arrow is pressed on a keyboard, however by using a gaze provoked interaction, the scrollable window may scroll down different amounts depending on the gaze provoked interaction. If this variable scrolling is not supported by the computer program directly controlling the on-screen component, the computer software may emulate supported functionality in order to provide the desired gaze provoked interaction. For example, the computer program may emulate the function of a scroll wheel in combination with an arrow on a keyboard. Any reference herein to the term “scroll” is intended to include a movement of content on a display in any direction, not limited to vertical, which renders more content viewable in the direction of the movement, and perhaps less content viewable in the direction opposite the movement. For example a scroll may be performed horizontally or diagonally in what may sometimes be referred to as a panning motion. In some embodiments, a scroll may be combined with a zooming of content to render more content viewable in the direction of the scroll, without correlated loss of viewable content in the direction opposite of the scroll.

Alternatively, a computer program may natively support a gaze provoked interaction providing enhanced functionality over a traditional interaction. In such cases, the computer program would contain executable instructions that may be invoked upon activation of a gaze provoked interaction. Typically, these instructions are added to the computer program during development of the computer program. The computer program could further comprise part of the operating system of the computing system, and thereby provide enhanced gaze provoked interaction as a standard interaction to any components capable of calling the interaction from the operating system. Many gaze provoked interactions are possible using embodiments of the invention.

A first gaze provoked interaction includes a computer program highlighting or otherwise marking a component on a display upon a gaze being detected at or near the component. For example, the computer program may highlight a button or text item when a user is gazing at the button or text item. In some embodiments, the highlighting or marking may include altering the overall color of the component, providing a visual indicator on or near the component, and/or shading the component in some way. Any method which distinguishes the component such that it is evident to the user that it is the intended target and is being gazed upon is suitable as highlighting/marking.

A second gaze provoked interaction includes a method of interacting with a map or other image displayed on a screen. In this interaction, a user may center the display of the map or image by gazing at a point and pressing a predefined key, button, or at least some portion of a touchpad. The computer software will then refresh the display of the image or map such that the point at which the user was gazing when the key or button was pressed will be at the center of the displayed image or map.

A third gaze provoked interaction includes enlarging or decreasing at least a portion of a displayed map or image (e.g., “zooming in/out”). In this interaction, a user may press a key, button, or some portion of a touchpad twice in quick succession on while gazing at a point (i.e., two inputs within a predetermined amount of time). Other non-gaze inputs may be used in place of pressing a key, button, or at least a portion of a touchpad. The computer software may then refresh the display such that the area around the point at which the user was gazing when the non-gaze input was received is displayed in greater detail (zoomed in) or lesser detail (zoomed out). In some embodiments, different keys/inputs may be associated with a desire to zoom out versus zoom in. For example, maintaining contact on a key, button or a portion of a touchpad while pressing another key, button or portion of a touchpad may indicate a desire to zoom out versus zoom in. In addition, the amount of pressure exerted upon a key, button or a portion of a touchpad may influence the speed at which a zoom action is performed. Further, although this interaction has been described with reference to a map or image, it functions equally with any form of component that is capable of zoom, this includes web pages, documents, folders, and the like. Whenever “zooming” in or out on a display is discussed herein, it will be understood to mean that the display increases or decreases the rendered size of graphical/textual content near a particular point on the display. When zooming in occurs, less of the content will be viewable on the display, but such lesser content will be displayed in greater detail. When zooming out occurs, more of the content will be viewable on the display, but such additional content, as well as the original content, will be displayed in lesser detail.

A fourth gaze provoked interaction includes interacting with a map or other displayed image, and provides another method by which to zoom in or zoom out. The interaction consists of holding down a key, button or touchpad while gazing at a point on the map or displayed image. The computer software refreshes the display such that the area around the point at which the user is gazing slowly zooms in or out until the key, button or touchpad is released. In some embodiments, different keys/inputs may be associated with a desire to zoom out versus zoom in. As a further improvement, the speed at which a zoom action is performed may be moderated by the length of time upon which pressure is maintained on the key, button or touchpad. For example the speed of the zoom action (i.e. the rate at which a magnification is increased or decreased) may increase or decrease at an exponential (or other) rate.

As a further improvement on the fourth gaze provoked interaction, while holding down a key, button, portion of a touchpad, or combination thereof, a map or displayed image/content may zoom out. In other words, the items displayed on the display may be altered such that it appears to the user that they reduce in size to give the impression of distance. Further items may be introduced to the display to enhance this impression. Whilst maintaining contact with the key, button, portion of a touchpad, or combination thereof, the user may move their gaze position around the zoomed out display. Once the user releases contact with the key, button, portion of a touchpad, or combination thereof, the display may zoom back to the original level of zoom, however at the gaze position of the user. In this manner, a user when viewing a large item such as a large image, map, text document, or 3D object may hold down a key, button, portion of a touchpad or combination thereof to provide a zoomed out view. Whilst continuing to hold down the key or the like, the user may select a new area on the zoomed out view to view in more detail, then release their pressure upon the key or the like and the display will zoom to the gaze position at the time of release of pressure. The magnification level of the zoomed in view may be that of the original view before pressure to the key or the like was applied, or it can be dynamically determined based on the nature of displayed items at the user's new gaze position.

In a further improvement of the fourth gaze provoked interaction, a zoom action may be executed by a pinching gesture performed on a touch sensitive surface using two or more fingers, including potentially five. Upon release of fingers from the touch sensitive surface or upon a pinching gesture in the opposite direction being performed, an opposing zoom action may be performed.

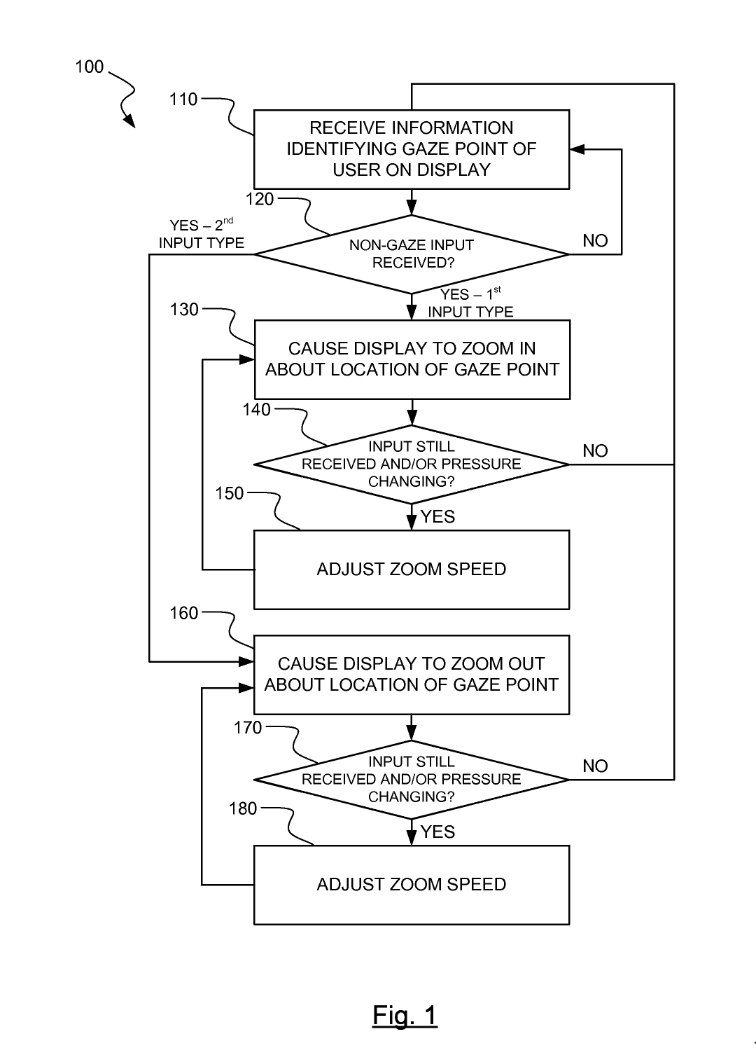

FIG. 1 is a block diagram of one method 100 of an embodiment of the invention for causing a zoom based on a gaze input. At block 110, information identifying a gaze point of a user on a display is received. At block 120, a non-gaze input is awaited. If such an input is not received, method 100 returns to block 110. However, if a first type of non-gaze input is received (for example, a press of the up-arrow key on an associated keyboard; or a left mouse click), then method 100 continues to block 130 and the display is zoomed in about the location of the gaze point. At block 140, if a consistent input with increasing magnitude, for example, pressure at a touch pad, is being received, then the zoom speed may be increased by some predetermined rate based at least in part on the increased magnitude of the input (e.g., exponentially, proportionally, etc.) at block 150.

If, at block 120, a second type of non-gaze input is received (for example, a press of the down-arrow key on the associated keyboard, or a right mouse click), then method 100 continues to block 160 and the display is zoomed out about the location of the gaze point. At block 170, if a consistent input with increasing magnitude, for example, pressure at a touch pad, is being received, then the zoom speed may be increased by some predetermined rate based at least in part on the increased magnitude of the input (e.g., exponentially, proportionally, etc.) at block 180.

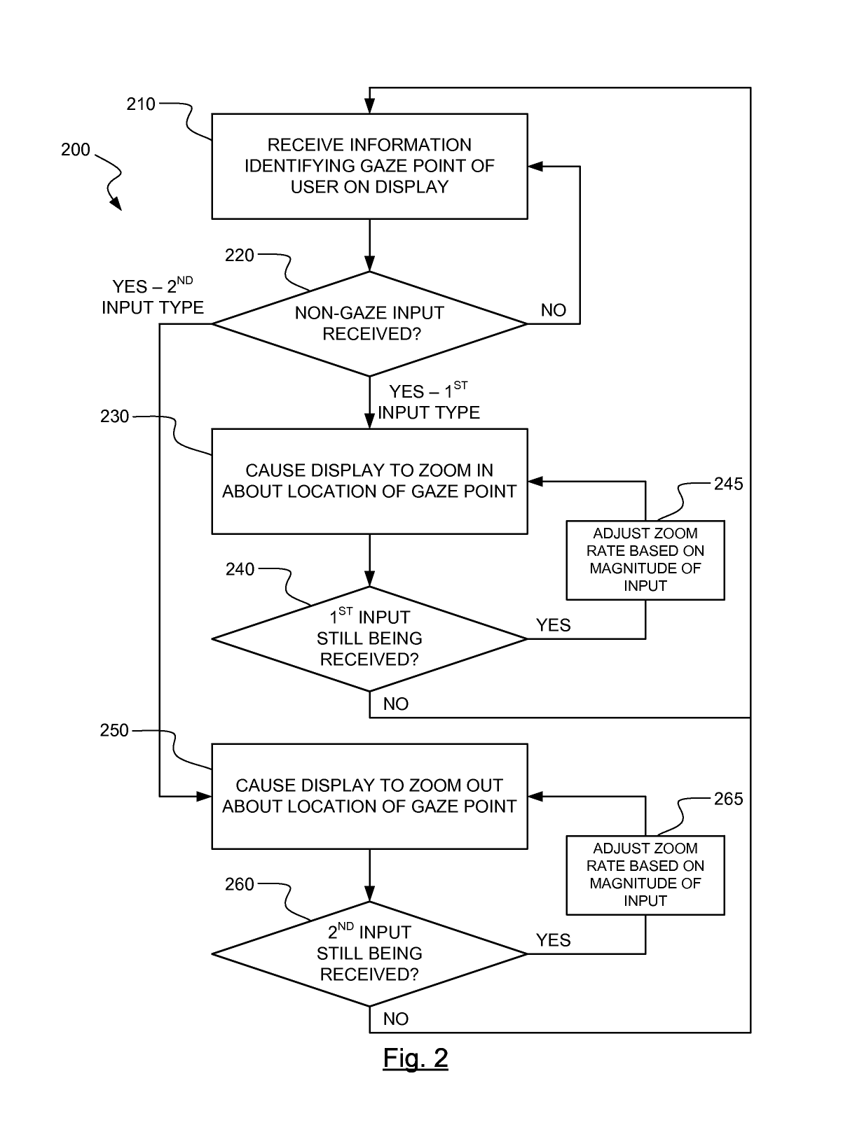

FIG. 2 is a block diagram of another method 200 of an embodiment of the invention for causing a zoom based on a gaze input. At block 210, information identifying a gaze point of a user on a display is received. At block 220, a non-gaze input is awaited. If such an input is not received, method 200 returns to block 210. However, if a first type of non-gaze input is received (for example, a press of the up-arrow key on an associated keyboard; or a left mouse click), then method 200 continues to block 230 and the display is zoomed in about the location of the gaze point. Then at block 240, the first input is monitored. If the input continues, then the display continues to zoom in at block 230. At block 245, the zoom rate may be adjusted in some embodiments if the magnitude (e.g., pressure at a touch pad) of an input is changing. The zoom rate may be adjusted in different manners relative to the change of input magnitude (e.g., proportionally, exponentially, etc.). If the input does not continue, then the zooming ceases, and method 200 returns to block 210. The amount of zoom in is dependent upon the particular embodiment of the invention implemented, as discussed herein.

If, at block 220, a second type of non-gaze input is received (for example, a press of the down-arrow key on the associated keyboard, or a right mouse click), then method 200 continues to block 250 and the display is zoomed out about the location of the gaze point. Then at block 260, the second input is monitored. If the input continues, then the display continues to zoom out at block 250. At block 265, the zoom rate may be adjusted in some embodiments if the magnitude (e.g., pressure at a touch pad) of an input is changing. The zoom rate may be adjusted in different manners relative to the change of input magnitude (e.g., proportionally, exponentially, etc.). If the input does not continue, then the zooming ceases, and method 200 returns to block 210. The amount of zoom out is dependent upon the particular embodiment of the invention implemented, as discussed herein.

A fifth gaze provoked interaction includes scrolling a display, window, or other particular area on a screen. The interaction may include scrolling in the direction of a user's gaze, whereby if a user is gazing in the lower half of the window or other area, upon pressing a predefined button, key, or at least some portion of a touchpad, the computer software refreshes the display such that the window or other area has scrolled down. If the user is gazing in the top half of the display or other area, the window or other area would alternatively scroll upwards upon the non-gaze input being received. In some embodiments, a visual indication on the display of the anticipated scroll direction, or of the half of the screen in which the user is gazing, may be provided. Any portion of the screen as defined by the computer software may constitute the area scrolled. For example, a third or quarter of the screen may be scrolled, or perhaps a particular window, depending on the embodiment. Further, scrolling may be initiated by the computer software upon the user gazing within a predefined area on the display, regardless of the user activating non-gaze input such as a key, button, touchpad, or the like. This may particularly be the case if the user has previously issued a command to the computer program that the user desires to implement the third gaze provoked interaction (discussed above) by gazing at a predetermined area of the screen, this command may be issued by pressing a key, button, touchpad, combination thereof, or the like. Additionally, in some embodiments, a previously issued command by the user may cause scrolling to occur based only on gaze-input (not requiring a non-gaze input to be received simultaneously). In these embodiments, a gaze input of a predetermined amount of time may be required to activate such automated scrolling.

A sixth gaze provoked interaction includes scrolling a window or other area or a screen by a predetermined amount based on a user's gaze. This interaction includes the computer software causing text or other information within a window or other area to scroll or move in a direction indicated by the user's gaze, whereby the text or other information scrolls a predetermined amount in one movement. In other words, the computer software, upon activation of the gaze provoked interaction, causes the window or other area to refresh such that a portion of text or other information that was not previously displayed is now displayed. The gaze provoked interaction may be activated by a user pressing a key, button, or touchpad or by simply gazing at a predefined point on the screen such as the top or bottom third or quarter of the screen (or other sub-portion of the display). Typically if the user gazing towards the top of the screen the text or other information will scroll downwards, whereas if the user gazes towards the bottom of the screen, the text or other information will scroll upwards.

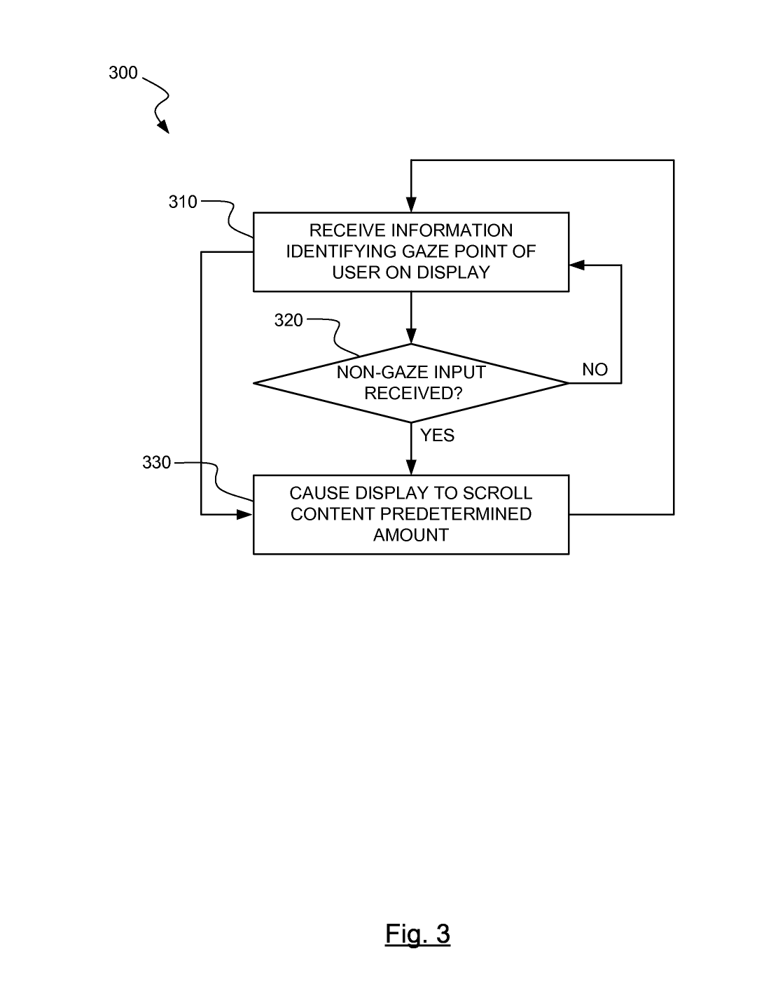

FIG. 3 is a block diagram of a method 300 of an embodiment of the invention for causing a scroll on a display based on a gaze input. At block 310, information identifying a gaze point of a user on a display is received. At block 320, a non-gaze input is awaited. If such an input is not received, method 300 returns to block 310. However, if an input is received, then method 300 continues to block 330 and the display is scrolled a predetermined amount (usually in a direction opposite the side of the display/content in which the gaze point is located). In some embodiments, no non-gaze input may be required to cause a scroll (i.e., a scroll could occur merely by the gaze point being located at a particular potion of the display).

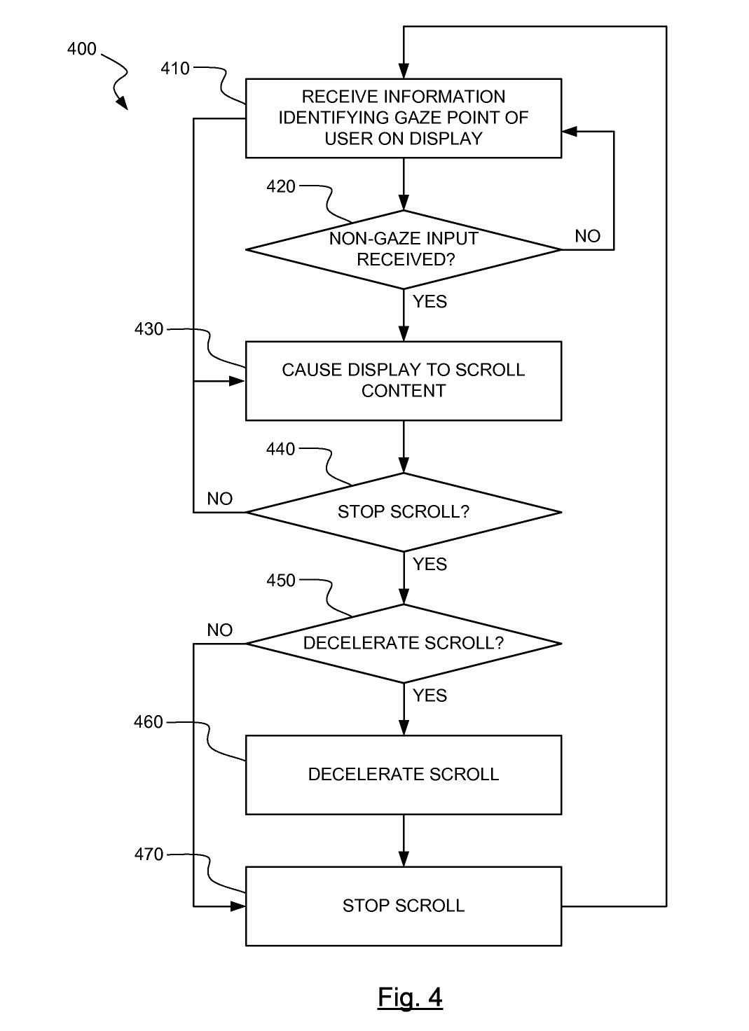

FIG. 4 is a block diagram of another method 400 of an embodiment of the invention for causing a scroll on a display based on a gaze input. At block 410, information identifying a gaze point of a user on a display is received. At block 420, a non-gaze input is awaited. If such an input is not received, method 400 returns to block 410. However, if an input is received, then method 400 continues to block 430 and the display is scrolled (usually in a direction opposite the side of the display/content in which the gaze point is located). In some embodiments, no non-gaze input may be required to cause a scroll (i.e., a scroll could occur merely by the gaze point being located at a particular potion of the display). Then at block 440, method 400 determines whether to stop the scrolling. This may occur for a number of reasons discussed herein (e.g., the gaze input moves from an edge of the screen or some sub-portion thereof (i.e., a window of text, etc.); a non-gaze input is received; etc.). If the scrolling is to be stopped, at block 450 it is determined whether the scrolling should be decelerated prior to a complete stop. Whether the scrolling should be decelerated prior to stopping is dependent on the particular embodiment of the invention. If the scrolling is to be decelerated prior to stoppage, then at block 460, deceleration of the scrolling occurs. Deceleration may occur at a natural rate, or some rate which is dependent on a rate or vector of a gaze point change. At block 470, whether or not deceleration occurs, scrolling is stopped, and method 400 returns to block 410.

A seventh gaze provoked interaction includes scrolling a window or other area based on length or pressure of contact by a user upon a key, button, or touchpad. This interaction consists of the computer software refreshing a displayed window or other area to show previously non-shown information or text so as to appear that the window or other area is scrolling. The amount of non-shown information that is shown during the change in display depends on the length and/or pressure the user places on a key, button, or touchpad. For example, if a user maintains pressure on a key, button, or touchpad the computer software may continually refresh the display to show non-shown information so as to provide the effect of continuously scrolling information. The length of contact with the key, button or touchpad may be used to control the rate at which non-shown information is shown. If the key, button or touchpad is capable of measuring pressure (such as a pressure-sensitive touchpad) the amount of pressure may be used to control the rate at which non-shown information is shown. The direction upon which non-shown information is scrolled from may change dynamically based on the user's gaze point. For example, the non-shown information may appear from below the display if the user's gaze point is located towards the bottom of the display but then shift dynamically to displaying non-shown information from the right of the display if the user's gaze point moves to the right of the display. This is particularly useful when scrolling across a displayed map or the like.

Further, regarding gaze provoked interactions that perform scrolling functions, it may be possible to terminate any scrolling which occurs in multiple fashions. First, the scrolling may be terminated by a user pressing a key, button, touchpad, or the like. Secondly, the scrolling may be terminated by the computer software slowly decelerating the scrolling so as to provide a natural stop. This may be combined with a movement of the user's gaze to a predetermined area of the screen, or away from the area upon which the user had initially gazed to commence scrolling. Thirdly, decelerating the text may be combined with the pressing of a key, button, touchpad or the like, such that when a user desires to terminated scrolling, pressing the key, button, touchpad or the like will commence a natural deceleration of the scrolling.

An eighth gaze provoked interaction includes displaying new information on a display based upon a user's gaze location. In this interaction, when a user presses and maintains pressure on a key, button, or at least a portion of a touchpad, the computer software displays a summary/list of computer programs currently running on the computer. As a further example, this summary/list may be displayed when pressure is maintained on more than one key, button, and/or portion of a touchpad. This summary/list may be in the form of miniature versions of the computer programs, graphical summaries of the programs, and/or text based summaries of the programs. As a further improvement, only a subset of running computer programs may be displayed to the user, for example only those meeting a predetermined criteria such as only those with displayable GUI components, or those that have been accessed within a predetermined time period. While pressure is maintained on the key, button, or touchpad, the computer program indicates which summary a user is gazing at (this may be performed by highlighting the summary). Upon release of the key, button, or touchpad the computer software causes the computer program to be displayed whose summary was the last gazed at by the user (and potentially highlighted). Further, if pressure is maintained on more than one key, button, or portion of a touchpad to display a summary of running programs, releasing pressure on any key, button or portion of a touchpad may cause the computer program to be displayed.

Further, maintaining pressure on a key, button or portion of a touchpad whilst pressing at least once another key, button, or portion of a touchpad may cause a summary of computer programs to be displayed. A computer program may then be selected either by pressing the second key, button, portion of a touchpad, or by locating a gaze point over the desired summary and releasing the first key, button or portion of a touchpad.

In a further improvement of the eight gaze provoked interaction, the display of running programs may be instituted by a pinching gesture performed on a touch sensitive surface using two or more fingers, potentially five. Upon release of fingers from the touch sensitive surface or upon an opposing pinching gesture being performed on the touch sensitive surface, the highlighted (by gaze point) summary may be selected and thus displayed.

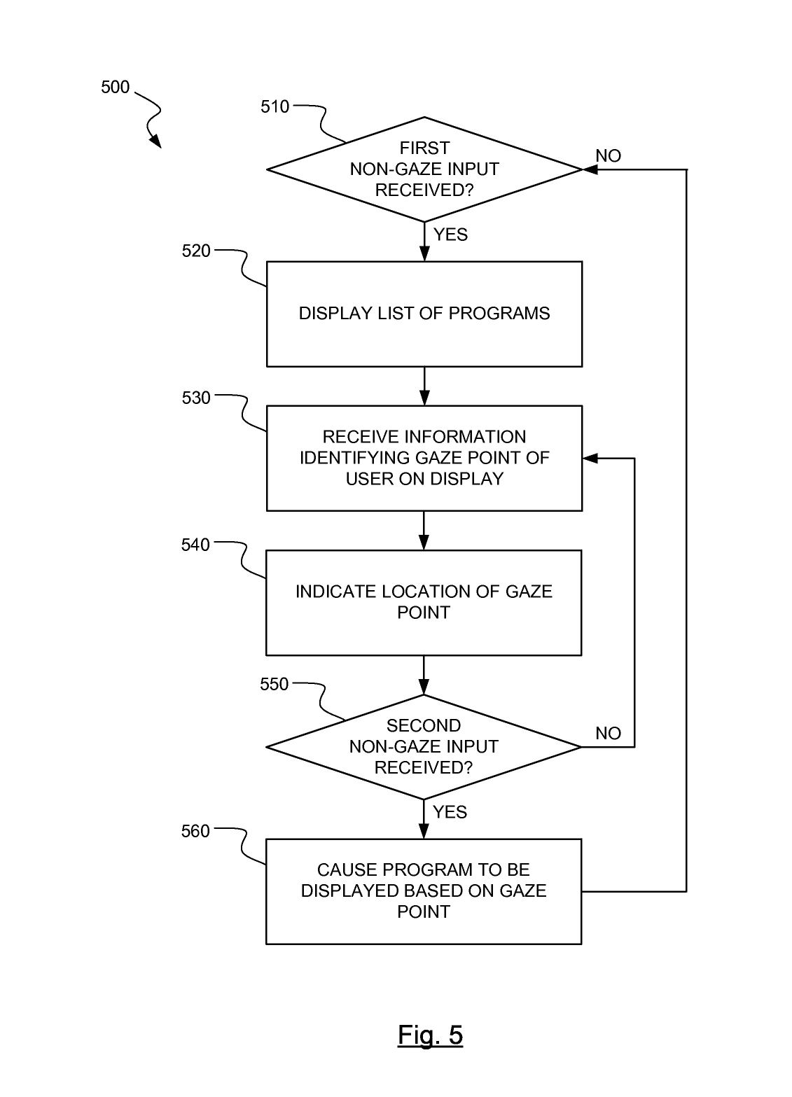

FIG. 5 is a block diagram of a method 500 of an embodiment of the invention for selecting a program from a list of programs based on a gaze input. At block 510, a first non-gaze input is awaited. When such input is received, at block 520 a summary/list of programs is displayed. As discussed above, the list may be presented in various formats. At block 530, information identifying the gaze point of the user on the display may be received. At block 540, the location of the gaze point may be indicated to the user. This may occur via highlighting or other indication of a particular program in the summary/list which the user is gazing at. At block 550, a second non-gaze input is awaited. If no second non-gaze input is received, then method 500 returns to block 530. However, if a second non-gaze input is received, then at block 560 the program in the summary/list at which the user's gaze point was lying is displayed and/or activated.

A ninth gaze provoked interaction includes implementing either a scrolling or zooming gaze provoked interaction dependent on the location of a user's gaze. This interaction may include the computer software determining in which area on the display a user is gazing and determining which type of gaze provoked interaction to commence. For example, if a gaze point is determined to be at the center of an area such as a map, image, document, or the like, the computer software may determine that a zooming action is appropriate. However, if a gaze point is determined near the edge of an area such as a map, image, document, or the like, the computer software may determine that a scrolling or panning action is appropriate.

Additionally the speed of a performed action may be altered based upon the area on a display at which the user is gazing. For example, if a user gazes directly at the edge of a map, image, document, or the like, the computer software may direct that an interaction be performed quickly whereas if the user gazes more towards the middle of a map, image, document, or the like, the computer software may direct that an interaction be performed slightly slower. This is particularly advantageous when centering an item on the display.

Regarding the afore-mentioned gaze provoked interactions, where a gaze provoked interaction has been described with reference to the activation of a key, button, touchpad, or the like, it is understood that the described functionality may be achieved by combining activation of input methods. For example, regarding the third gaze provoked interaction, it is possible for the interaction to be performed by maintaining pressure on a first key, button, touchpad, or the like while pressing a second key, button, touchpad or the like. Further, it is possible that an interaction could be defined by maintaining pressure on a key, button, touchpad or the like and speaking a command. As a further example, an interaction could be activated by speaking a command on its own.

It is intended that any reference to a key, button, touchpad and the like also includes any form of non-gaze input that may be activated by a user. This includes screens that are capable of touch detection to receive an input. Further this may include other forms of input such as voice, gestures, brainwave detection, and the like.

It is intended that any reference to a computing system or the like include any device capable of executing instructions such that information is shown on a display. This includes computing devices such as mobile telephones, tablet computers, gaming devices, and the like.

The computing device(s) or systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. In particular it is intended that the invention function with personal computers, laptops, tablet, mobile telephones, and wearable devices such as virtual reality, augmented reality, display, or helmet systems.

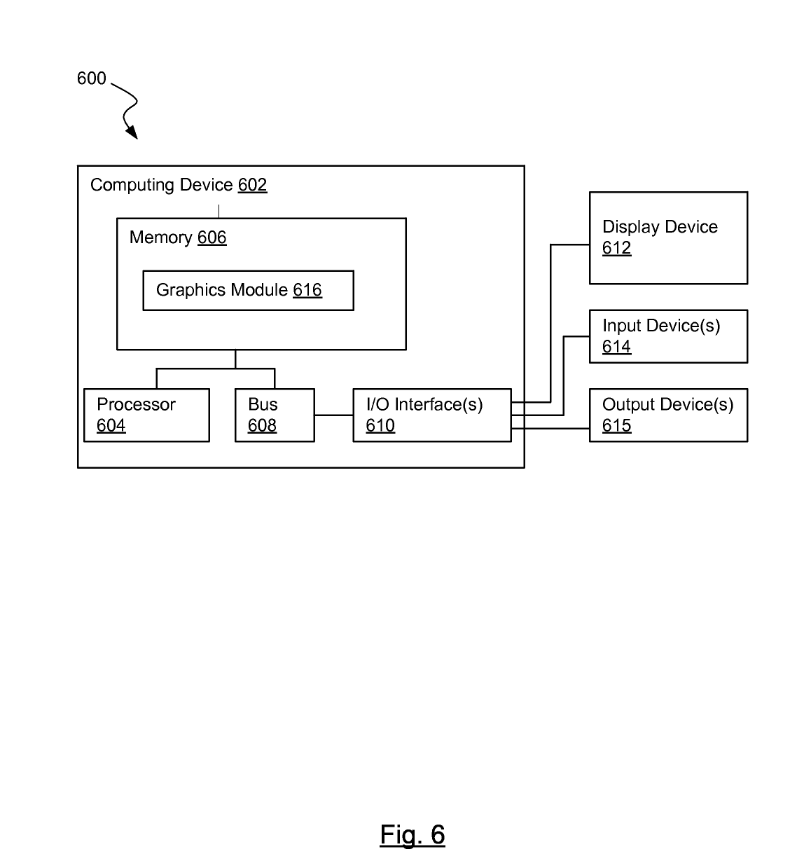

By way of example and not limitation, FIG. 6 is a block diagram depicting an example computing device 602 for implementing certain embodiments. The computing device 602 can include a processor 604 that is communicatively coupled to a memory 606 and that executes computer-executable program instructions and/or accesses information stored in the memory 606. The processor 604 may comprise a microprocessor, an application-specific integrated circuit (“ASIC”), a state machine, or other processing device. The processor 604 can include any of a number of computer processing devices, including one. Such a processor can include or may be in communication with a computer-readable medium storing instructions that, when executed by the processor 604, cause the processor to perform the steps described herein.

The computing device 602 can also include a bus 608. The bus 608 can communicatively couple one or more components of the computing system 602. The computing device 602 can also include and/or be communicatively coupled to a number of external or internal devices, such as input or output devices. For example, the computing device 602 is shown with an input/output (“I/O”) interface 610, a display device 612, input device(s) 614 and output device(s) 615.

Non-limiting examples of a display device 612 include a screen integrated with the computing device 602, a monitor external and coupled with the computing system, etc. Non-limiting examples of input devices 614 include gaze detection devices, touch screens, touch pads, external mouse devices, microphones and/or other devices mentioned herein, etc. A non-limiting example of an output device 615 is an audio speaker. In some embodiments, the display device 612, the input device(s) 614 and the output device(s) 615 can be separate devices. In other embodiments, the display device 612 and at least some of the input device(s) 614 can be integrated in the same device. For example, a display device 612 may be a screen and an input device 614 may be one or more components providing eye-tracking and/or touch-screen functions for the display device, such as emitters for emitting light and/or cameras for imaging a user's eye(s) and/or a touch area, etc. The screen, input device components and any output device components may be integrated within the same housing or in other integrated configurations.

The computing device 602 can modify, access, or otherwise use electronic content. The electronic content may be resident in any suitable non-transitory computer-readable medium and execute on any suitable processor. In one embodiment, the electronic content can reside in the memory 606 at the computing system 602. In another embodiment, the electronic content can be accessed by the computing system 602 from a remote content provider via a data network.

The memory 606 can include any suitable non-transitory computer-readable medium. A computer-readable medium may include, but is not limited to, electronic, optical, magnetic, or other storage device capable of providing a processor with computer-readable instructions or other program code. Other examples comprise, but are not limited to, a floppy disk, CD-ROM, DVD, magnetic disk, memory chip, ROM, RAM, an ASIC, a configured processor, optical storage, magnetic tape or other magnetic storage, or any other medium from which a computer processor can read instructions. The instructions may comprise processor-specific instructions generated by a compiler and/or an interpreter from code written in any suitable computer-programming language, including, for example, C, C++, C#, Visual Basic, Java, Python, Perl, JavaScript, and ActionScript.

A graphics module 616 stored in the memory 606 can configure the processor 604 to prepare electronic content for rendering in a graphical interface and/or render the electronic content in the graphical interface. In some embodiments, the graphics module 616 can be a stand-alone application executed by the processor 604. In other embodiments, the graphics module 616 can be a software module included in or accessible by a separate application executed by the processor 604 that is configured to modify, access, or otherwise use the electronic content.

It should be understood that the various methods described herein for interacting with and controlling computer devices and computer programs may be implemented by way of computer-readable instructions or other program code, which may have various different and alternative functional arrangements, processing flows, method steps, etc. Any suitable programming, scripting, or other type of language or combinations of languages may be used to implement the teachings contained herein in software to be used in programming or configuring a computing device.

Unless specifically stated otherwise, it is appreciated that throughout this specification discussions utilizing terms such as “processing,” “computing,” “calculating,” “determining,” and “identifying” or the like refer to actions or processes of a computing device. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

Numerous specific details are set forth herein to provide a thorough understanding of the subject matter of the various embodiments. However, those skilled in the art will understand that such subject matter may be practiced without some or all of these specific details. In other instances, methods, apparatuses, or systems that would be known by one of ordinary skill have not been described in detail so as not to obscure claimed subject matter.

While the present subject matter has been described in some detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

The invention has now been described in detail for the purposes of clarity and understanding. However, it will be appreciated that certain changes and modifications may be practiced within the scope of the appended claims.

What is claimed is:

1. A method for selecting a program from a list of programs, wherein the method comprises:
receiving an indication that a first non-gaze input has been received;
causing a list of programs to be shown on a display;
receiving information identifying a location of the gaze point of the user on the display;
receiving an indication that a second non-gaze input has been received; and
based at least in part on the location of the gaze point, causing a program from the list to be shown on the display upon receipt of the second non-gaze input.

2. The method for selecting a program from a list of programs of claim 1, wherein:
the first non-gaze input comprises a selection from a group consisting of:
a key press;
a button press; and
a touch on a touchpad.

3. The method for selecting a program from a list of programs of claim 2, wherein:
the second non-gaze input comprises a selection from a group consisting of:
release of the key;
release of the button; and
removal of the touch on the touchpad.

4. The method for selecting a program from a list of programs of claim 1, wherein:
the first non-gaze input comprises maintaining pressure on a selection from a group consisting of:
a key;
a button; and
a touchpad.

5. The method for selecting a program from a list of programs of claim 4, wherein:
the second non-gaze input comprises releasing pressure on a selection from a group consisting of:
the key;
the button; and
the touchpad.

6. The method for selecting a program from a list of programs of claim 1, wherein:
the first non-gaze input comprises performing a gesture on a touch-sensitive surface.

7. The method for selecting a program from a list of programs of claim 6, wherein:
the second non-gaze input comprises releasing contact with the touch-sensitive surface.

8. The method for selecting a program from a list of programs of claim 1, wherein:
causing the list of programs to be shown on the display comprises causing a list of at least a portion of the programs currently running on a system to be shown on the display.

9. The method for selecting a program from a list of programs of claim 8, wherein:
causing the list of programs to be shown on the display comprises causing reduced size versions of the programs to be displayed.

10. The method for selecting a program from a list of programs of claim 1, further comprising:
causing a program in the list of programs to be highlighted or otherwise denoted when the gaze point of the user is located at the program in the list of programs.

11. A non-transitory machine readable medium having instructions stored thereon for selecting a program from a list of programs, the instructions executable by at least one processor for at least:
receiving an indication that a first non-gaze input has been received;
causing a list of programs to be shown on a display;
receiving information identifying a location of the gaze point of the user on the display;
receiving an indication that a second non-gaze input has been received; and
based at least in part on the location of the gaze point, causing a program from the list to be shown on the display upon receipt of the second non-gaze input.

12. The non-transitory machine readable medium of claim 11, wherein:
the first non-gaze input comprises a selection from a group consisting of:
a key press;
a button press; and
a touch on a touchpad.

13. The non-transitory machine readable medium of claim 12, wherein:
the second non-gaze input comprises a selection from a group consisting of:
release of the key;
release of the button; and
removal of the touch on the touchpad.

14. The non-transitory machine readable medium of claim 11, wherein:
the first non-gaze input comprises maintaining pressure on a selection from a group consisting of:
a key;
a button; and
a touchpad.

15. The non-transitory machine readable medium of claim 14, wherein:
the second non-gaze input comprises releasing pressure on a selection from a group consisting of:
the key;
the button; and
the touchpad.

16. The non-transitory machine readable medium of claim 11, wherein:
the first non-gaze input comprises performing a gesture on a touch-sensitive surface.

17. The non-transitory machine readable medium of claim 16, wherein:
the second non-gaze input comprises releasing contact with the touch-sensitive surface.

18. The non-transitory machine readable medium of claim 11, wherein:
causing the list of programs to be shown on the display comprises causing a list of at least a portion of the programs currently running on a system to be shown on the display.

19. The non-transitory machine readable medium of claim 18, wherein:
causing the list of programs to be shown on the display comprises causing reduced size versions of the programs to be displayed.

20. The non-transitory machine readable medium of claim 11, wherein:
causing a program in the list of programs to be highlighted or otherwise denoted when the gaze point of the user is located at the program in the list of programs.
